(19) United States
(12) Patent Application Publication
(10) Pub. No.: US 2014/0090633 A1
(43) Pub. Date: Apr. 3, 2014

(54) BARBECUE GRILL HAVING HANDLE WITH LIGHTING DEVICE

(71) Applicant: The Brinkmann Corporation, Dallas, TX (US)

(72) Inventors: Brandon Gleaton, Dallas, TX (US); Lance R. Thompson, West Chicago, IL (US); Randall L. May, Plano, TX (US); Owen Slater, Plano, TX (US); Wesley Crabbe, Dallas, TX (US)

(73) Assignee: The Brinkmann Corporation, Dallas, TX (US)

(21) Appl. No.: 14/040,458

(22) Filed: Sep. 27, 2013

Related U.S. Application Data
(60) Provisional application No. 61/707,727, filed on Sep. 28, 2012.

(51) Int. Cl. A47J 37/07

(52) U.S. Cl. CPC A47J 37/0786
USPC 126/213

(57) ABSTRACT

A barbecue grill comprising a grilling surface, a hood, a handle for opening the hood, and a lighting device interconnected with the handle. The lighting device is mounted in such a way that when the hood is opened, the lighting device can be used to illuminate the grilling surface.

### CROSS-REFERENCE TO RELATED APPLICATION

This application claims the benefit of U.S. Provisional Application Ser. No. 61/707,727, filed Sep. 28, 2012, the entire contents of which are herein incorporated by reference as if fully set forth herein.

### BACKGROUND OF THE INVENTION

The present invention relates generally to outdoor barbecue grills, and more particularly to outdoor barbecue grills having lighting devices so that users can see items as they cook on the grill in low light conditions.

Outdoor barbecue grills are used to cook food outdoors, generally over an open flame. These grills generally come in gas or charcoal varieties. When cooking outside in the evening, a common challenge that grill users face is a lack of direct natural light on the grilling surface. When there is not sufficient light, the user of the grill is unable to clearly see the food as it cooks on the grill, making it difficult to determine whether the food is cooking correctly. This can make it difficult to cook on an outdoor grill during the evening.

Additionally, grilling will often require the use of both of the user's hands to holding spatulas, tongs, plates, food or the like, and to open and close the hood of the grill. Grill users often find that they do not have enough hands to perform all of these basic grilling tasks at the same time. This makes it inconvenient, and sometimes even impossible, for the user to hold a lighting device in one hand while engaged in grilling activities. It is also difficult to hold a lighting device in place if the food requires constant attention for an extended period of time as it is grilled.

It can readily be appreciated that there is a need for outdoor barbecue grills with lighting devices positioned such that the grill user can see the grilling surface and the food being cooked on it when natural light by itself is insufficient. It can also be readily appreciated that there is a need for a way to light the grilling surface without occupying one of the grill user's hands. The present invention fulfills these needs and provides further related advantages.

### SUMMARY OF THE INVENTION

The present invention resides in a barbecue grill comprising a grilling surface, a hood, a handle for opening the hood, and a lighting device interconnected with the handle. The lighting device is mounted in such a way that when the hood is opened, the lighting device can be used to illuminate the grilling surface.

In a presently preferred embodiment, by way of example, a lighting device may be built into the handle. The lighting device includes a pair of lighting heads with illumination sources that emit light. When the hood is opened, each lighting head may be oriented such that each illumination source emits light directed at the grilling surface in order to illuminate it. Preferably the lighting device is battery-operated and uses one or more LEDs as the source of illumination. A switch to turn the illumination sources on and off may be built-into the lighting device.

In the presently preferred embodiment, the lighting device including its lighting heads is substantially integrated into and serves as part of the handle. In this manner, the lighting device-may itself be as easily gripped for opening and closing the hood as any other portion of the handle.

In a further aspect of the invention, the lighting device may be repositionable when the hood is open to re-orient the illumination sources of the lighting device to illuminate the grilling surface. For example, at least a portion of the lighting device having an illumination source may be moved between a closed position and an opened position relative to the handle. In the opened position, the lighting device's illumination source may extend out from the handle to reposition the illumination source over the grilling surface to better illuminate it. In the preferred embodiment, the lighting heads are rotatably mounted to the handle, allowing them to be rotated crosswise to the handle so that their illumination sources extend out over the grilling surface.

In yet a further aspect of the invention, an on-off switch for the lighting device may be configured to automatically turn on its illumination source when the lighting device is moved from the closed position to the opened position, and to automatically turn off the illumination source when the lighting device is moved back to the closed position.

The invention may also reside in a stand-alone lighting device for use with a barbecue grill, wherein the lighting device is removably attachable to the handle of the barbecue grill so that it can be positioned to illuminate the grilling surface of the grill. The stand-alone lighting device may be attached to the handle of the grill through the use of an elastic clip.

Other features and advantages of the invention should become apparent from the following description of the preferred embodiments, taken in conjunction with the accompanying drawings, which illustrate, by way of example, the principles of the invention.

### BRIEF DESCRIPTION OF THE DRAWINGS

A presently preferred embodiment of the present invention will now be described, by way of example only, with reference to the following drawings.

FIG. 1 is a perspective view of a barbecue grill having a handle, wherein the handle has a pair of built-in lighting devices shown in a closed position, in accordance with the presently preferred embodiment of the present invention.

FIG. 2A is a perspective view of the barbecue grill of FIG. 1, with the grill hood opened and the light devices still in a closed position.

FIG. 2B is a perspective view of the barbecue grill of FIG. 1, wherein the grill hood is opened and the lighting devices rotated crosswise to the handle into an opened position.

FIG. 3A is a close-up front view of the grill handle with the pair of built-in lighting devices shown in the closed position.

FIG. 3B is a close-up front view of the grill handle with the pair of built-in lighting devices shown in the opened position.

FIG. 4A is a close-up top view of the grill handle with the pair of built-in lighting devices shown the closed position.

FIG. 4B is a close-up top view of the grill handle with the pair of built-in light devices shown in the opened position.

FIG. 5A is a perspective view of an unassembled lighting device.

FIG. 5B is a close-up of the right side of the unassembled lighting device show in FIG. 5A.

FIG. 6A is a close-up of the right side of the unassembled lighting device in which the lighting head is rotated beyond the opened position to reveal an exposed electrical contact on the lighting head.

FIG. 6B is a view from behind the lighting head of FIG. 6A to reveal an exposed electrical contact on the lighting base.

FIG. 7A is a bottom view of the lighting device with the lighting heads in the opened position.

FIG. 7B is a bottom view of the lighting device with the lighting heads in a substantially closed position.

### DETAILED DESCRIPTION OF THE PREFERRED EMBODIMENTS

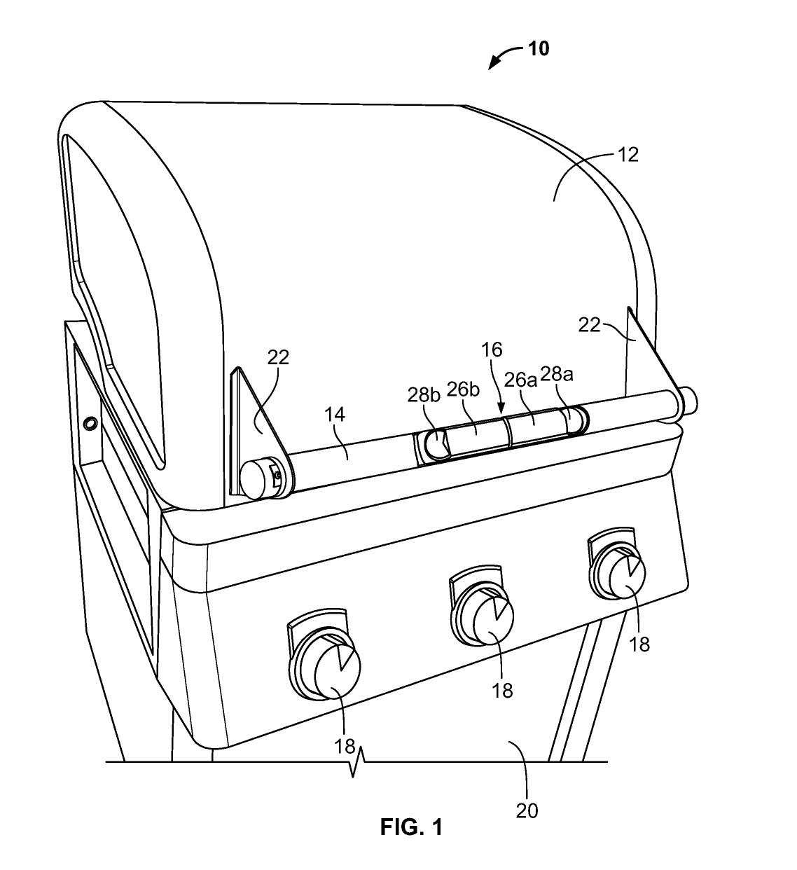

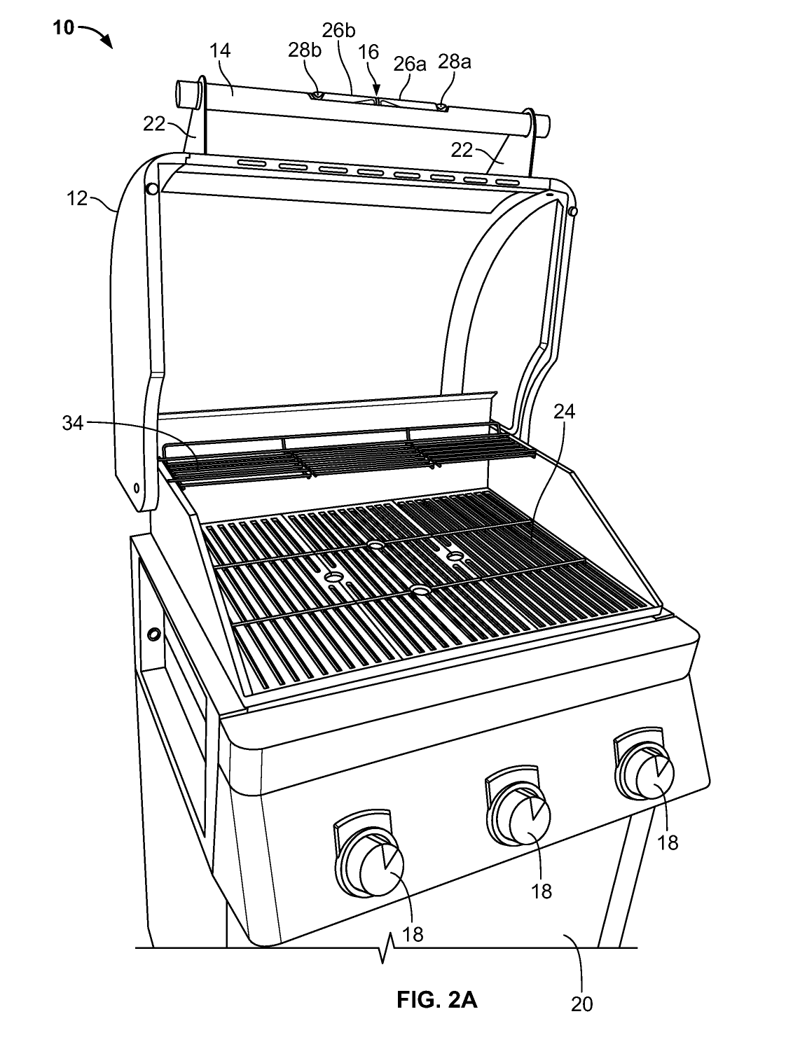

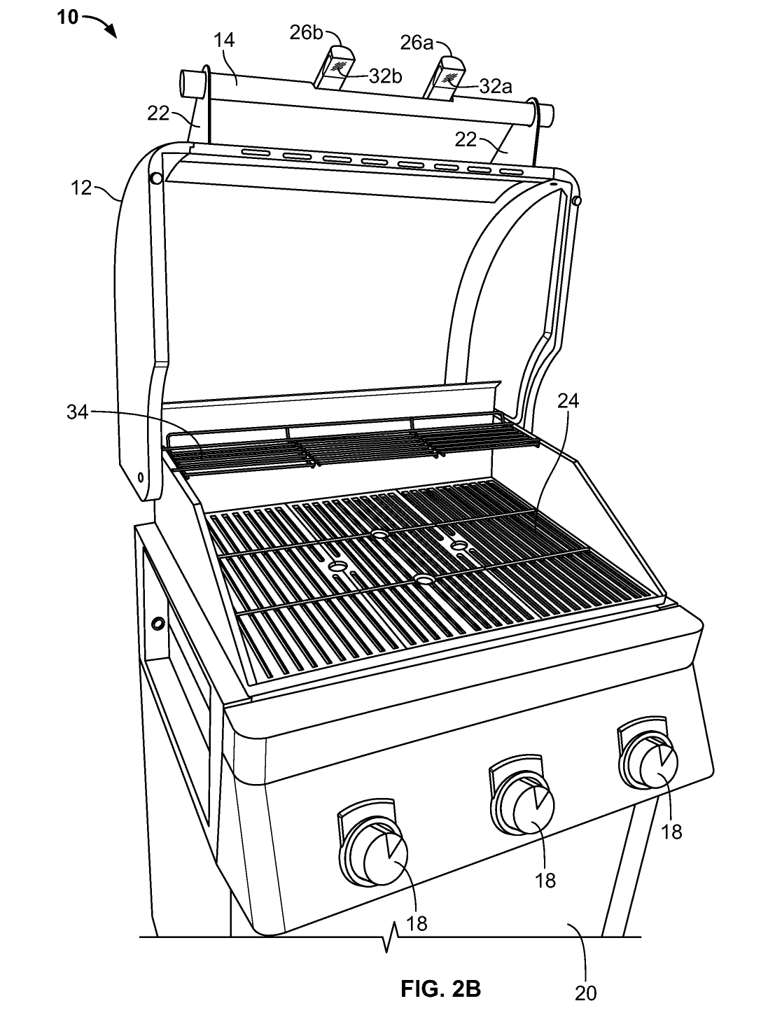

Referring now to the drawings, and particularly to FIG. 1 thereof, there is shown a perspective view of a barbecue grill 10 having a hood 12, a handle 14, and a lighting device 16 interconnected with the handle, in accordance with the presently preferred embodiment of the invention. The grill otherwise is a typical grill with gas control knobs 18 and a base 20. As shown in FIGS. 2A-2B, the hood pivots open from near its lower rear corners to reveal a grilling surface 24. The handle is connected to the hood by end brackets 22 attached to the hood near its lower front.

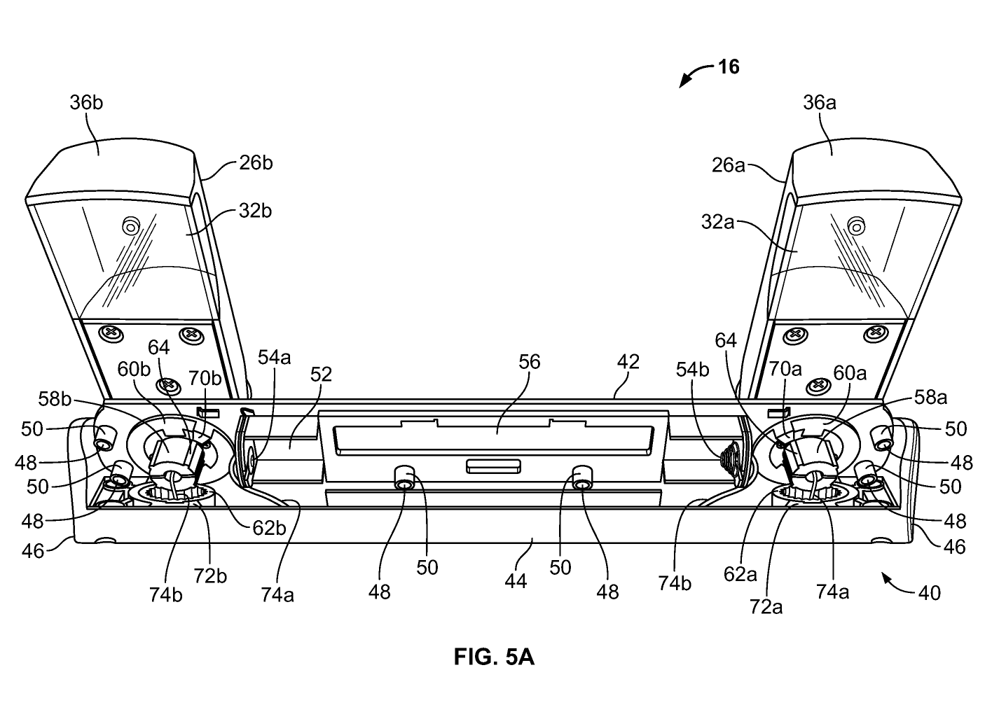

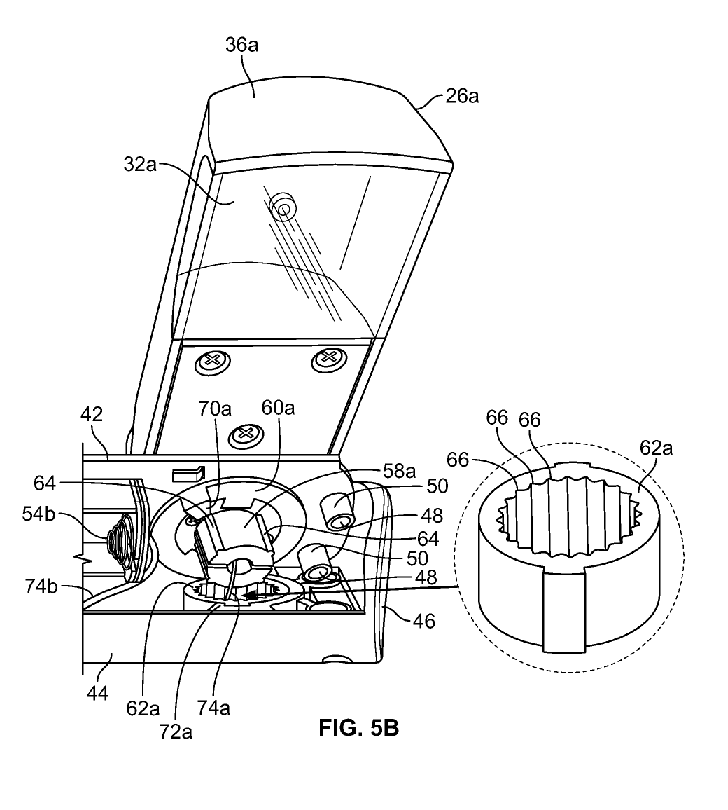

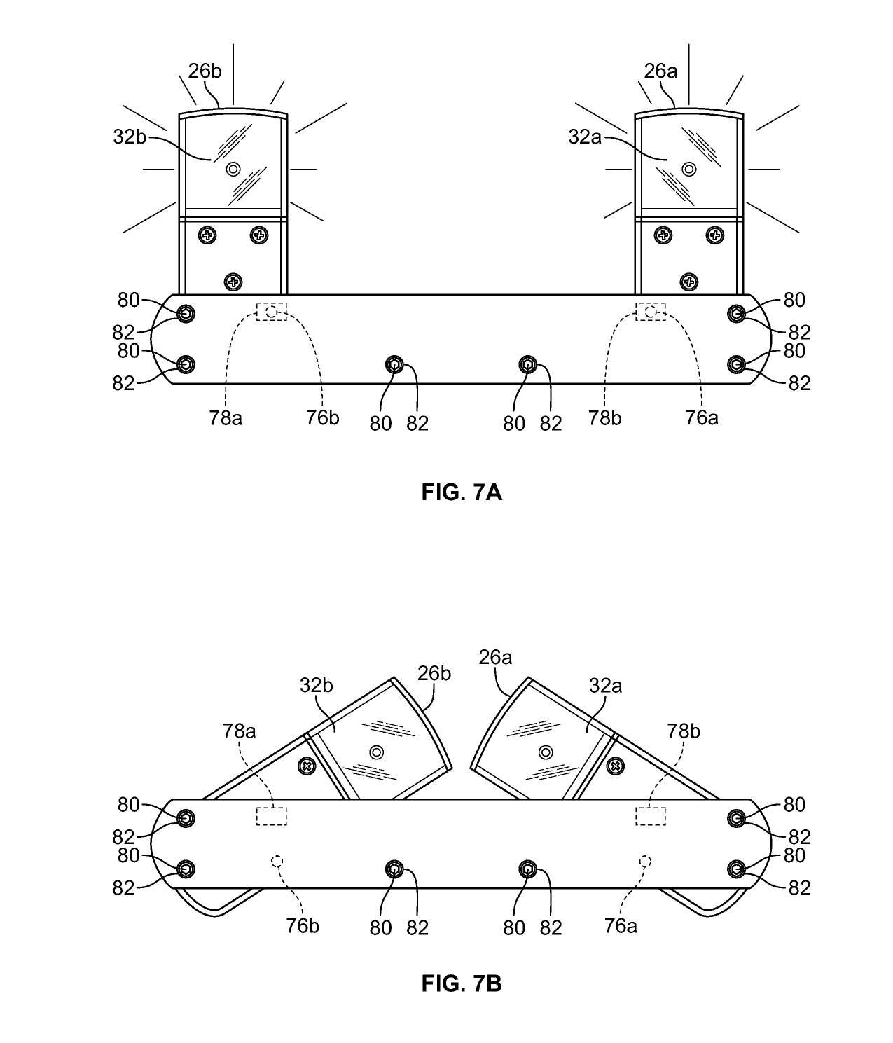

As discussed in more detail below, the lighting device 16 has a generally cylindrical, elongate shape and is a self-contained unit that is built into the handle 14. In FIG. 1, it can be seen that the upper half of the lighting device is divided longitudinally into an opposed pair of lighting heads 26a and 26b. The lighting heads are each rotatably mounted at their outer ends 20a, 20b to the outer ends of a lighting base 40 (not shown in FIG. 1), which forms the lower half of the lighting device contained within the handle. See FIGS. 5A-5B and 7A-7B.

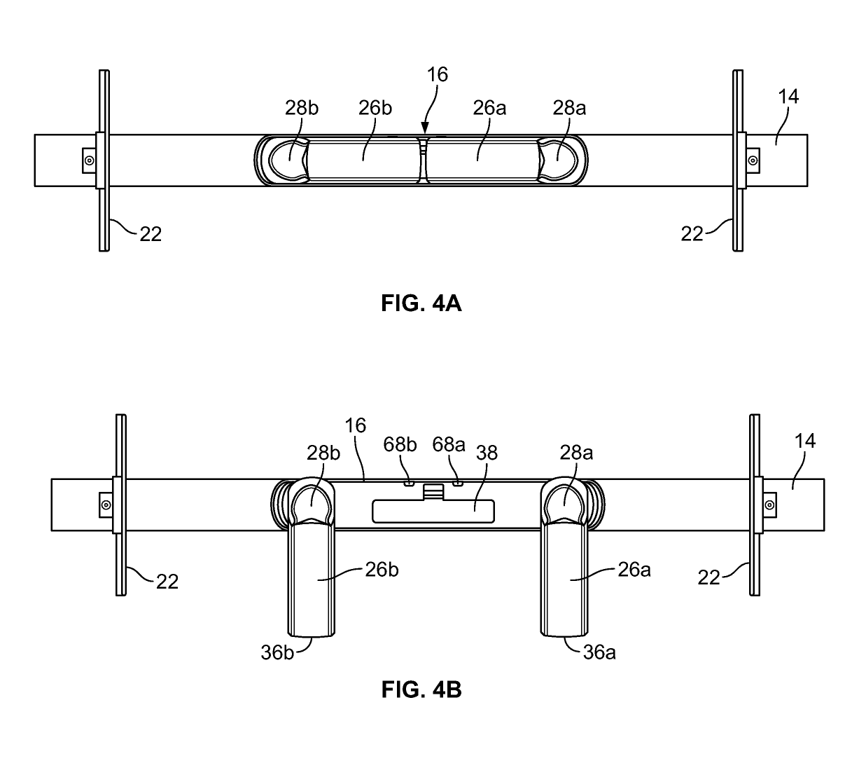

FIGS. 2A and 2B show the grill 10 of FIG. 1 with the hood 12 of the grill opened, as it would be when a user is cooking food on a grilling surface 24 of the grill. In the preferred embodiment, the handle 14 is formed of a generally hollow cylindrical tube, and the lighting device 16 is received within an elongate cutout 30 formed in the handle. As shown in FIGS. 2A, 3A and 4A, when not in use, the lighting heads 26a and 26b may be folded into a closed position on the lighting device 16, such that the lighting device is substantially integrated into and serves as part of the handle. When it is desired to use the lighting device, the outer ends 28a, 28b of each lighting head allows the user to rotate them from the closed position to an opened position in which one or both lighting heads extend crosswise to the handle, as shown in FIGS. 2B, 3B and 4B. FIG. 4B is a top view of the handle that shows the exposed upper surface of the base 40 of the lighting device when the lighting heads are in the opened position. In an alternative embodiment, rather than the lighting device being built into the handle of the grill, the lighting device may be a stand-alone lighting device that is removably attachable to the grill handle. For example, the lighting device may include an elastic clip that can be used to clip the lighting device onto the grill handle, and then the lighting device could be removed from the grill handle when it is no longer needed.

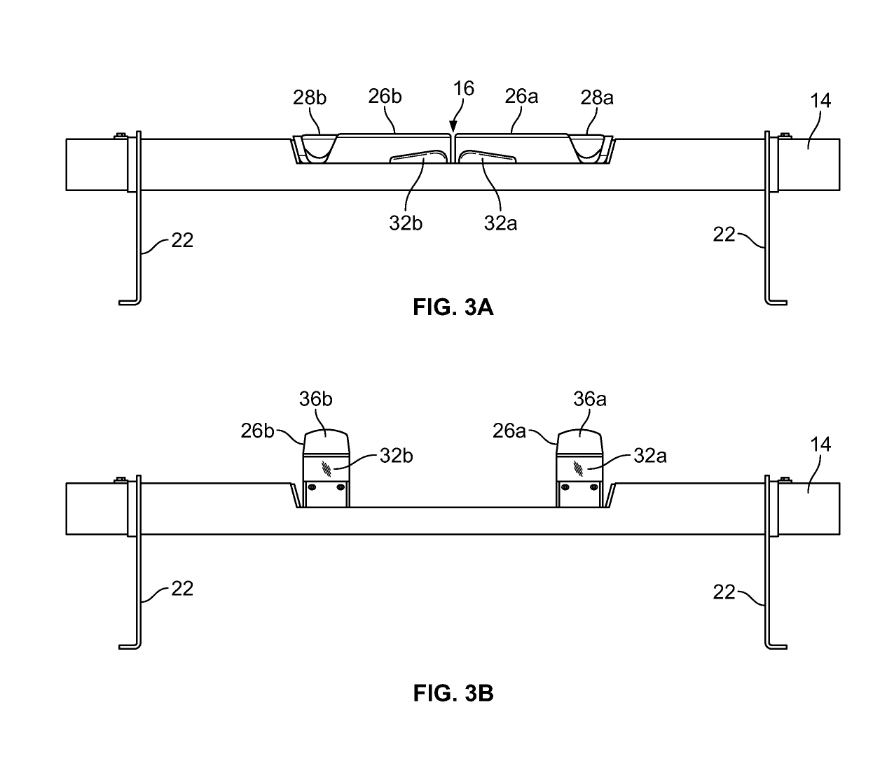

As shown in FIGS. 2B and 3B, the inner ends of the lighting heads 26a and 26b of the lighting device 16 each has a generally rectangular, transparent lens 32a, 32b mounted on its lower surface. The lenses enclose a light emitting source (not shown), which can be used to illuminate the grilling surface 24 when the lighting heads are in the opened position. The lighting heads may use any conventional light-emitting source, but preferably use LEDs as the source of illumination. Rotating the lighting heads to the opened position orients the lenses of the lighting heads above the grilling surface 24, as well as over a warming rack 34. In the opened position, the light emitted through the lenses illuminates the grilling surface so that the user can more clearly see the food as it cooks. The lighting device is angled slightly upward on the handle. The lighting device is placed at this upward angle so that the light emitting sources on the lighting heads are at a more optimal angle to light the grilling surface. Due to this slightly upward angle, the transparent lenses 32a and 32b are visible from the front when the lighting heads 26a and 26b are in the opened position. FIG. 3B provides this front-perspective view, where the inner end walls 36a, 36b of the lighting heads are visible just above the transparent lenses 32a, 32b.

The base 40 of the lighting device 16 is shown in more detail in FIGS. 5A and 5B. As shown in the partially assembled view of FIG. 5A, the base has a two-piece construction comprising a top shell 42 and a bottom shell 44. The bottom shell has a generally hollow, semi-cylindrical shape with upstanding end walls 46 that are circular in shape and slope somewhat outwardly. The bottom shell with its end walls is configured to fit within the cutout 30 in the handle 14. The top shell is generally planar and is configured to fit on top of the bottom shell between its end walls. The base is held together by inserting screws 80 in through bores 82 in the bottom shell 44 (shown in FIGS. 7A-7B) that thread into openings 48 formed in standoffs 50 on the inside surface of the top shell.

The central portion of the base 40 comprises a battery compartment 52 with conventional battery terminals 54a, 54b at each end to mechanically hold and make electrical connection with a pair of batteries (not shown). An opening 56 for inserting and removing the batteries is formed in the top shell 42, and a separate cover 38 is provided for the battery opening that snaps into place in conventional manner.

As previously discussed, the outer ends of the lighting heads 28a, 28b are rotatably mounted at the outer ends of the lighting base 40. To achieve this, each lighting head at its outer end has a generally cylindrical mounting stem 58a, 58b, respectively, that is fixedly attached to its bottom surface. The mounting stems extend through openings (not shown) in the top shell 42 of the lighting base, and are held in place from the inside of the top shell by enlarged flanges 60a, 60b, respectively, that mate with the mounting stems. The enlarged flanges sandwich the top shell between their respective lighting heads and mounting stem, serving to hold the lighting heads firmly in place on the top shell, while allowing the lighting heads and mounting stems to rotate relative to the top shell. A pair of generally cylindrical bushings 62a, 62b are fixedly attached to the inside of the bottom shell 44 at opposite ends to receive the mounting stems with a snug fit when the top shell and the bottom shell are assembled together.

It is preferable that the lighting heads 26a, 26b are mounted so that they are not free to rotate on their own, but only rotate when acted on by the user. To this end, the mounting stem 58a, 58b has four equiangularly-spaced ribs or teeth 64 formed longitudinally along its outer cylindrical surface, and the inner cylindrical surface of the bushing has twenty-four complementary grooves 66 formed longitudinally continuously around its inner cylindrical surface. Both the mounting stem and the bushing preferably are formed of a durable nylon or plastic material. When the mounting stem is inserted into the bushing, the teeth on the stem are received in the grooves in the bushing. This serves to resist rotation of the lighting heads and “lock” them in position relative to the lighting base, but the elasticity of the mounting stem and bushing materials, and the fact that there are only four teeth on each mounting stem, allow the user, with application of moderate force, to rotate the lighting head in step-wise fashion. With twenty-four grooves in the bushing, six steps are required for each lighting head to be rotated between the closed position and the opened position (one-quarter rotation). The upstanding end walls 46 of the lighting base 40 act as stops to prevent the lighting heads from being rotated more than one-quarter rotation in either direction. A pair of upstanding tabs 68a, 68b are formed on the upper surface of the top shell 42, near the center along the edge closest to the hood 12. These tabs are provided to block the lighting heads from rotation past the closed position on the base toward the hood. Extensions 70a, 70b on the enlarged flanges provide an additional stop mechanism to prevent the lighting heads from being rotated more than one-quarter rotation in either direction. As the lighting heads 26a, 26b are turned, the flanges turn with them. Stop-walls 72a, 72b built into the bottom shell 44 prevent the extensions on the flanges from turning beyond the opened position. Mirroring stop-walls on the opposite, rear side of the bottom shell (not shown) prevent the extensions from turning beyond the closed position.

In the preferred embodiment, each lighting head 26a, 26b is provided with a built-in switch so that it turns on automatically as it is rotated to the opened position and turns off automatically as it is rotated back to the closed position. To this end, the illumination sources in each lighting head are connected by wires to one of the two terminals 54a, 54b in the battery compartment 52, but are not connected to the opposite terminal 54b, 54a, as the case may be. For example, the illumination source in lighting head 26a is connected by a wire 74a (through a bore in the mounting stem 58a) to the positive conductor 54a, but is not connected to the negative conductor 54b as it needs to be to form a complete electrical circuit. The opposite is true for the lighting head 26b, which is connected by a wire 74b (through a bore in the mounting stem 58b) to the negative terminal 54b, but is not connected to the positive terminal 54a. Switching on of each of the illumination sources in the lighting heads is controlled by completing these missing electrical connections to form complete circuits.

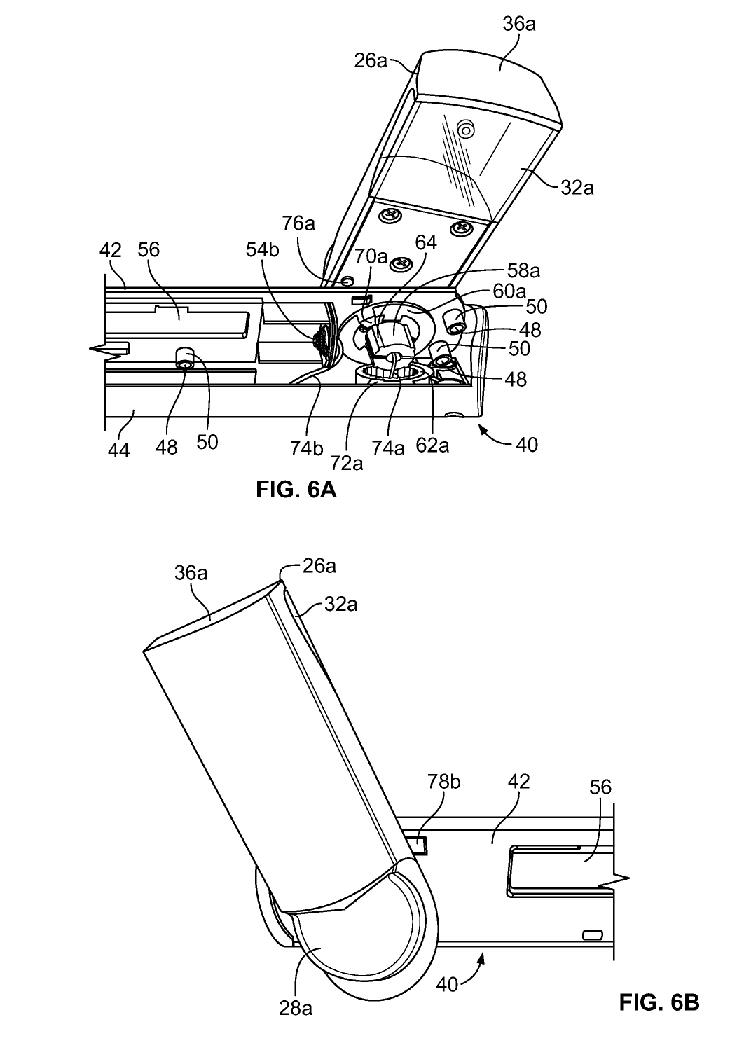

FIGS. 6A-6B shows how these missing electrical connections are completed. FIGS. 6A-6B show close-ups of lighting head 26a, but it should be understood that lighting head 26b is a mirror image. Lighting head 26a has an exposed electrical contact 76a on its bottom surface. On the upper surface of top shell 42, underneath the lighting head 26a, there is an exposed electrical contact 78b. This exposed contact on the top shell is connected to the nearest battery terminal, which, in this case, is the negative terminal 54b. For lighting head 26b, the exposed electrical contact 78a on the upper surface of the top shell is connected to the positive battery terminal 54a. When the exposed electrical contact 76a on the lighting head 26a comes into contact with the exposed electrical contact 78b on the top shell, the electrical connection between the illumination source in lighting head 26a and the negative terminal 54b is established, completing the electrical circuit for the illumination source in the lighting head 26a. Conversely, when exposed electrical contact on lighting head 26a is not in contact with the exposed electrical contact on the top shell, the illumination source remains off. It will therefore be apparent that the illumination source in each lighting head can be switched on and off independently of the illumination source in the other lighting head, if desired.

FIGS. 7A and 7B further illustrate how rotation of the lighting heads 26a and 26b result in automatic on-off switching of their illumination sources. When the lighting heads are in the closed position, the exposed electrical contacts 76a, 76b on the lighting heads are not in contact with the exposed electrical contacts 78b, 78a on the top shell. However, when the lighting heads are in the opened position, the exposed electrical contacts light conductors on the lighting heads are in contact with the exposed electrical contacts on the top shell, thus turning on the illumination sources in the lighting heads. In the preferred embodiment, the exposed electrical contacts on the lighting heads and the exposed electrical contacts on the top shell are positioned such that when the lighting heads are at an angle of between 75 and 90 degrees with the handle 12, the respective exposed electrical contacts on the lighting heads and the top shell come into contact, and when the lighting heads are at an angle of less than 75 degrees with the handle, these exposed electrical contacts are not contact.

Although the invention has been disclosed with reference only to a presently preferred embodiment, those of ordinary skill in the art will appreciate that various modifications can be made without departing from the invention. Accordingly, the invention is defined only by the following claims.

What is claimed is:

1. A grill comprising:
a firebox;
a grilling surface housed within the firebox;
a hood positioned over the grilling surface so as to be able to substantially enclose the grilling surface within the firebox, the hood having a handle; and
a lighting device connected to the handle, wherein
the lighting device is positioned such that when the hood is open, revealing the grilling surface to be accessed by a user, the lighting device is able to illuminate at least a portion of the grilling surface.

2. The grill of claim 1, wherein the lighting device comprises lighting head having an illumination source that emits light.

3. The grill of claim 2, wherein the illumination source is an LED.

4. The grill of claim 1, wherein the lighting device is built into the handle.

5. The grill of claim 4, wherein the lighting device is substantially integrated into and serves as part of the handle.

6. The grill of claim 5, wherein,
the lighting device comprises a lighting head, the lighting head comprising an illumination source that emits light, and further wherein
the lighting device may be moved between an opened position and a closed position with respect to the handle, such that
when the lighting device is in a closed position, it is substantially integrated into and serves as part of the handle, and
when the lighting device is in an opened position, the illumination source is positioned over the grilling surface to better illuminate the grilling surface.

7. The grill of claim 6, wherein the lighting head is rotatably mounted to the handle such that the lighting head may rotated between the closed position, in which the lighting head is rotated to be substantially in line with the handle, and the opened position, in which the lighting head is rotated to extend beyond the handle, over the grilling surface.

8. The grill of claim 7, wherein the lighting device further comprises an on-off switch.

9. The grill of claim 8, wherein the on-off switch is configured to
automatically turn on the illumination source when the lighting device is moved from the closed position to the opened position, and
automatically turn off the illumination source when the lighting device is moved from the opened position to the closed position.

10. A method for operating a barbecue grill, the barbecue grill comprising
a firebox,
a grilling surface housed within the firebox,
a hood positioned over the grilling surface so as to be able to substantially enclose the grilling surface within the firebox, the hood having a handle,
a lighting device built into the handle such that the lighting device is substantially integrated into and serves as part of the handle,
the method comprising:
opening the hood of the grill using the handle to reveal the grilling surface;
moving the lighting device from a closed position, in which the lighting device is substantially in line with the handle, to an opened position, in which an illumination source of the lighting device is positioned over the grilling surface; and
illuminating the grilling surface using the lighting device.

11. The method of claim 10, wherein the illumination source is an LED.

12. The method of claim 10, wherein the lighting device is configured to
automatically turn on the illumination source when the lighting device is moved from the closed position to the opened position, and
automatically turn off the illumination source when the lighting device is moved from the opened position to the closed position.

13. The method of claim 10, wherein the lighting head is rotatably mounted to the handle such that the step of moving the light device from a closed position to an opened position comprises rotating a lighting head from a closed position, in which the lighting head is substantially in line with the handle, to an opened position, in which the lighting head extends beyond the handle and over the grilling surface.

14. The method of claims 12 and 13, wherein
the opened and closed positions are defined by the angle created by the rotating lighting head and the handle, such that the lighting device is configured to
automatically turn on the illumination source when the angle formed by the lighting head and the handle is greater than a pre-determined angle, and
automatically turn off the illumination source when the angle formed by the lighting head and the handle is less than the pre-determined angle.
